(19) United States
(12) Patent Application Publication
(10) Pub. No.: US 2011/0035703 A1
(43) Pub. Date: Feb. 10, 2011

(54) ELECTRONIC DEVICE, CONTROL METHOD AND STORAGE MEDIUM

(75) Inventors: Hisashi NEGISHI, Kawasaki (JP); Takashi Kogure, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/818,823

(22) Filed: Jun. 18, 2010

Related U.S. Application Data
(63) Continuation of application No. PCT/JP2007/074760, filed on Dec. 21, 2007.

(51) Int. Cl. G06F 3/048

(52) U.S. Cl. 715/802

(57) ABSTRACT

An electronic device on which a multi-window system operates. The electronic device includes a detecting unit to detect a switchover of an active window, and a volume control unit to change, when the switchover of the active window is a switchover to another window from a sound output window defined as a user interface for a process of outputting a sound, a volume setting value relating to the output sound by the process of the sound output window.

### CROSS-REFERENCE TO RELATED APPLICATIONS

This is a continuation of Application PCT/JP2007/074760, filed on Dec. 21, 2007, now pending, the entire contents of which are herein wholly incorporated by reference.

### FIELD

The present invention relates to a technology of displaying moving pictures in a multi-window system.

### BACKGROUND

An electronic device (a computer etc.) has hitherto been broadly utilized, which adopts a software system configured to enable a plurality of windows to be simultaneously displayed on a display screen, i.e., a multi-window system.

The electronic device, on which this multi-window system operates, can simultaneously execute a plurality of programs and can display representations based on these programs in respective windows. For example, it is feasible to mainly utilize other functions (such as creating a document and checking mails) while viewing a moving picture or listening to music.

A user selects an application to be utilized in a way that selectively switches over these windows with a pointing device such as a mouse, etc.

In the case of performing other operations while outputting a sound of the moving picture or the music, it is preferable that a volume of the output sound be set relatively small (low) as in the case of BGM (Back Ground Music). Namely, when performing other operations while outputting the sound of the moving picture or the music, the volume is desirably set smaller than in the case of enjoying the sound of the moving picture or the music.

Therefore, in the case of performing other operations while listening to the sound of the moving picture or the music, the user conducts an operation of reducing (lowering) the moving picture reproduced sound each time.

Further, for example, technologies disclosed in the following Patent documents are given by way of the prior arts related to the invention of the present application.

[Patent Document 1]

Japanese Patent Laid-Open Publication No. H07-49763

[Patent Document 2]

Japanese Patent Laid-Open Publication No. H07-44348

As described above, the reduction of the volume in the case of performing other operations while listening to the sound of the moving picture or the music, leads to a problem, in which the user's operation is needed and is time-consuming as well. Moreover, the user, when finishing a process of another window or getting interested in and wanting to thoroughly enjoy the moving picture or the music and if the volume remains small with a difficulty of listening, conducts an operation of returning the volume to a normal level. Then, further for getting back to the main operation, a switchover to another window is made, on which occasion the operation of frequently changing the volume such as decreasing the volume is repeated, resulting in a problem that this operation is quite troublesome.

### SUMMARY

Such being the case, there is provided a technology of lightening a user's time-consuming operation by automatically changing a volume setting value of an output sound corresponding to a switchover of a window.

According to an aspect of the present invention, an electronic device on which a multi-window system operates includes: a detecting unit to detect a switchover of an active window; and a volume control unit to change, when the switchover of the active window is a switchover to another window from a sound output window defined as a user interface for a process of outputting a sound, a volume setting value relating to the output sound by the process of the sound output window.

According to another aspect of the present invention, a control method, executed by an electronic device on which a multi-window system operates, includes: detecting a switchover of an active window; and changing, when the switchover of the active window is a switchover from a sound output window to another window, a volume setting value relating to the output sound by a process of the sound output window.

According to still another aspect of the present invention, a non-transitory storage medium is stored with a program that causes, when read and executed by the electronic device, the electronic device to perform: detecting a switchover of an active window; and changing, when the switchover of the active window is a switchover from a sound output window to another window, a volume setting value relating to an output sound by a process of the sound output window.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a functional block diagram of an electronic device according to an embodiment;

FIG. 2 is a schematic diagram of a personal computer serving as the electronic device;

FIG. 3 is a diagram illustrating a controller B1;

FIG. 4 is an explanatory flowchart of a control method according to a first embodiment;

FIG. 5 is an explanatory flowchart of a process of updating a volume of a moving picture reproduced sound and a setting value;

FIG. 6 is a flowchart illustrating a modified example of the control method;

FIG. 7 is an explanatory diagram of a user interface for setting the setting value of the volume;

FIG. 8 is a flowchart illustrating a modified example of the control method;

FIG. 9 is an explanatory flowchart of the control method in a second embodiment;

FIG. 10 is an explanatory diagram of a status of a window that is switched over by the control method;

FIG. 11 is an explanatory diagram of the status of the window switched over by the control method;

FIG. 12 is a flowchart illustrating a modified example of the control method;

FIG. 13 is an explanatory diagram of a setting procedure of a window size;

FIG. 14 is an explanatory diagram in the case of changing a moving picture display window to a small size; and

FIG. 15 is an explanatory diagram in the case of changing the moving picture display window to the small size.

### DESCRIPTION OF EMBODIMENTS

Preferred embodiments of the present invention will be explained with reference to accompanying drawings. Configurations in the following embodiments are exemplifications, and the present invention is not limited to the configurations in the embodiments.

### First Embodiment

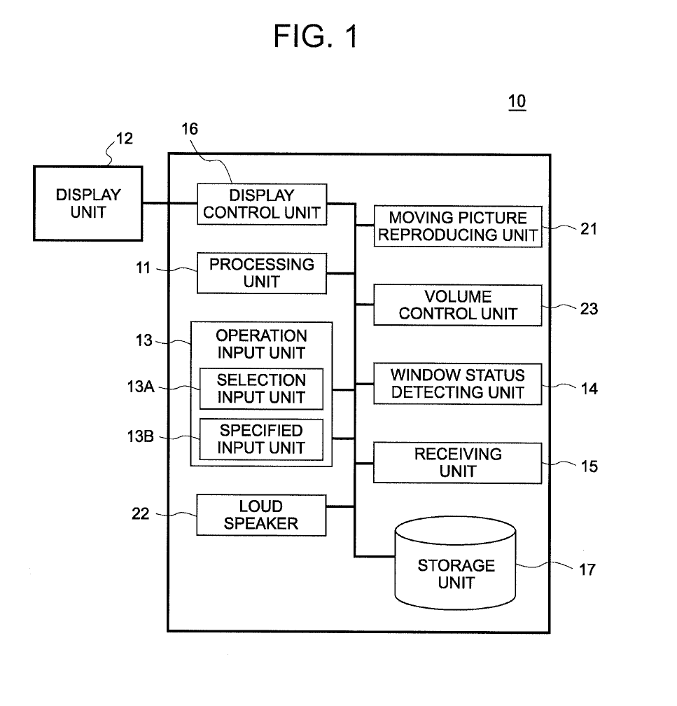

FIG. 1 is a function block diagram of an electronic device according to the present embodiment. An electronic device 10 in this embodiment automatically changes a volume setting value of an output sound in a way that corresponds to a switchover of a window. It is to be noted that the present embodiment exemplifies, as the output sound, audio (voice and/or sound) of a moving picture (which will hereinafter be simply referred to as a moving picture reproduced sound) of a television, a DVD, etc, however, the output sound is, it may be sufficient, output as a sound of music and a sound of the radio.

The electronic device 10 includes a processing unit 11 capable of simultaneously executing a plurality of processes, a display unit 12 which displays the results of the processes, an operation input unit (user interface) 13 which inputs information on a user's operation to the processing unit etc., a window status detecting unit 14 which detects a switchover of an active window, a receiving unit 15 which receives moving picture information of a TV program etc., a display control unit 16 which controls a window etc to be displayed on the display unit 12, a storage unit 17 accumulated (stored) with programs and data used by the processing unit etc, a moving picture reproducing unit 21, a loud speaker 22 and a volume control unit 23.

The processing unit 11 is capable of performing operations of a so-called multi-window system which simultaneously executes a variety of processes such as displaying a moving picture, creating a document, transmitting and receiving a mail, and displaying results of these processes in respective windows.

The operation input unit 13 has a selection input unit 13A such as a keyboard and a pointing device used for a user to select and then input an operation target window, and a specific input unit 13B such as a remote controller, a volume and a function key (soft key, shortcut key, etc.) for conducting an input for a specific function corresponding to the user's operation.

The window status detecting unit 14 detects which status, an active status or a non-active status, a sound output window defined as a user interface for a sound output process as in the case of a so-called media player is switched over to. Incidentally, according to this embodiment, it is detected which status, the active status or the non-active status, the window for displaying the moving picture (which will hereinafter be simply referred to as a moving picture display window) is switched over to. To be specific, when the user switches from the selected status of the moving picture display window to an another-window-selected status through the selection input unit 13A, the window status detecting unit 14 detects the switchover of the moving picture display window to the non-active status from the active status. On the other hand, when the user selects the moving picture display window from the another-window-selected status through the selection input unit 13A, the window status detecting unit 14 detects the switchover of the moving picture display window from the non-active status to the active status.

The receiving unit 15 is a so-called tuner that obtains moving picture information by receiving a broadcast from a broadcasting station. Further, the receiving unit 15 may be a set-top box that receives the moving picture information via a cable and may also be a communication control unit (which is a so-called network card) for receiving the moving picture information via a network such as the Internet.

The moving picture reproducing unit 21, by executing decoding process etc., generates a video signal in a display-enabled format and an audio signal from the moving picture information received by the receiving unit 15 or the moving picture information stored in the storage device 17, then displays the picture on a display unit 12 by transmitting the video signal to the display control unit 16, and simultaneously outputs the sound (moving picture reproduced sound) from the loud speaker 22 by transmitting the audio signal to this loud speaker 22.

The volume control unit 23 changes a volume of the moving picture reproduced sound of the moving picture reproducing unit 21, corresponding to a change in master volume of an OS and/or a change in setting value of the output sound of the moving picture, the music, and so on. In particular, the volume control unit 23 in the present embodiment, if the active window is switched over to another window from the sound output window defined as the user interface for the sound output process, changes a volume setting value relating to the output sound generated by the process of the sound output window.

The respective units of the electronic device 10 may be constructed of dedicated electronic circuits (hardware), and at least some of the units thereof may also be realized softwarewise in such a way that a program runs on a general-purpose computer.

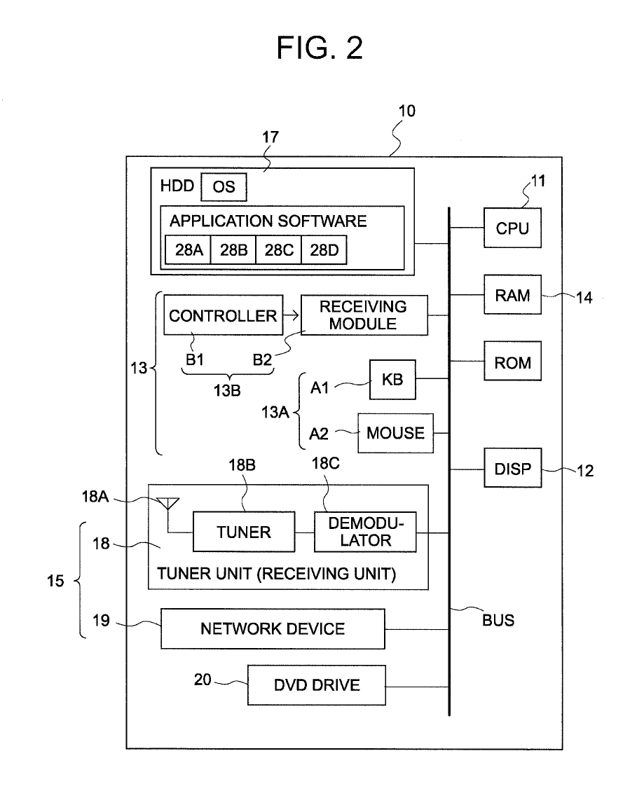

FIG. 2 is a schematic diagram of a personal computer serving as the electronic device in this embodiment.

A computer 10 is a general-purpose computer (information processing device) including a CPU 11, the display unit (an LCD in this embodiment) 12, the operation input unit 13, a main memory 14, the receiving unit 15, the storage unit 17, a tuner unit (TV tuner) 18, a network device 19 and a DVD drive 20.

The storage unit 17 is a storage device (a hard disc in this embodiment) installed with an operating system (OS) and pieces of application software (a control program etc.). The control program in this embodiment includes moving picture reproducing programs (a TV reproducing application 28A, a DVD moving picture reproducing application 28B and a network distribution moving picture reproducing application 28C) and a display control program 28D.

The operation input unit 13 is equipped with a keyboard and a mouse as the selection input unit 13A and a remote controller 13B as the specific input unit 13B.

The remote controller 13B is an operation unit for performing an operation related dedicatedly to a moving picture reproducing function, and is constructed of a controller B1 and a receiving module B2. The controller B1 transmits operation information wirelessly as carried on the light or radio waves. The receiving module B2 is mounted in the computer 10 and feeds the operation information received from the controller B1 to the CPU 11 etc. via a bus.

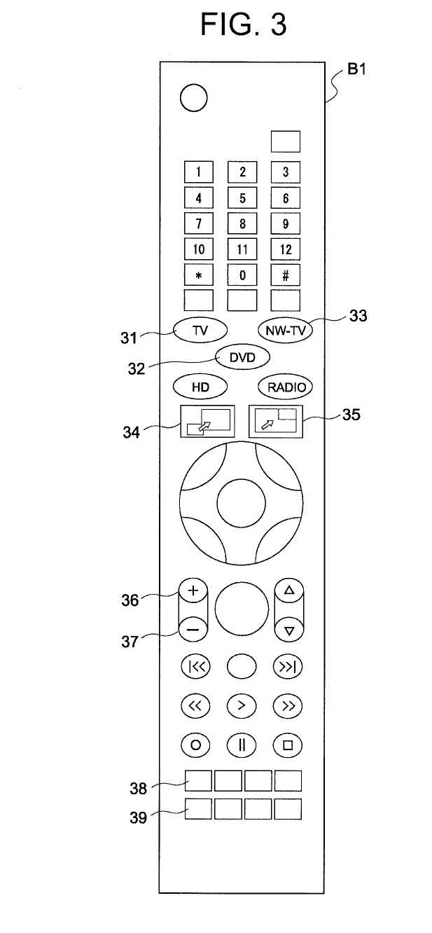

FIG. 3 is a diagram illustrating the controller B1 according to this embodiment. The controller B1 has a TV button 31 used for starting up and invoking the TV reproducing application 28A, a DVD button 32 used for starting up and invoking the DVD moving picture reproducing application 28B, a network TV button 33 used for starting up and invoking the network distribution moving picture reproducing application 28C, an enlargement button 34 for enlarging the moving picture display window (e.g., a button that causes the moving picture display window to be enlarged by 10% each time when being pressed, a button that causes the moving picture display window to be enlarged to a standard size or a first window size that will be described later on), a reduction button 35 for reducing the moving picture display window (e.g., a button that causes the moving picture display window to be reduced by 10% each time when being pressed, a button that causes the moving picture display window to be reduced to a small size or a second window size that will be described later on), a volume-up button 36 for increasing a volume of the moving picture reproduced sound, a volume-down button 37 for decreasing the volume of the moving picture reproduced sound, a button 38 for reregistering a standard volume (a first value) and a button 39 for registering a volume (a second value) when in the non-active status. The user presses these buttons and is thereby enabled to start up the respective moving picture reproducing applications, invoke the moving picture reproducing applications each running on the background, get restored from a power saving mode of the personal computer 10, get restored from the power saving mode of the display unit 12, change the size of the moving picture display window, change the volume of the moving picture reproducing sound, change the setting value of the volume, and so on.

The receiving device 15 includes a tuner unit 18 and a network device 19.

The tuner unit 18 has an antenna 18A, a tuner 18B and a demodulator 18C, and is controlled by the CPU 11 that executes a device driver. The tuner unit 18 receives broadcasting waves by use of the antenna 18A and selects a channel by employing the tuner 18B.

Then, the tuner unit 18 executes a demodulating process based on the broadcasting waves of the channel by using the demodulator 18C and a process of generating a compressed moving picture data stream (TS signal in this embodiment). The thus-generated TS signal is output via the bus.

The CPU 11 executing the TV reproducing application 28A generates, on the basis of the TS signal output by the tuner unit 18, a picture of each of frames assembled to form the moving picture (a decoding process). Then, the video signal based on the generated pictures is output to the display unit 12, and a screen image (video) based on the video signal is displayed on the display unit 12, thereby enabling the user to view the TV broadcast.

The network device 19 is a device for performing the communication with the outside via a cable or wirelessly and is controlled by the CPU 11 executing a device driver. The network device 19 receives packets transmitted from an on-network server via the network such as the Internet, and outputs the received packets via the bus.

The CPU 11 executing the network distribution moving picture reproducing application 28C generates the picture of each of the frames assembled to form the moving picture on the basis of the packets output from the network device 19 (the decoding process). Then, the video signal based on the generated pictures is output to the display 12, and the screen image based on the video signal is displayed on the display unit 12, thereby enabling the user to view a network distribution moving picture.

The DVD drive 20 is a device for reading information recorded on an inserted DVD and is controlled by the CPU 11 executing a device driver. The DVD drive 20 outputs, via the bus, the information that is read from the DVD. The CPU 11 executing the DVD moving picture reproducing application 28B generates the picture of each of the frames assembled to form the moving picture on the basis of the information output from the DVD drive 20 (the decoding process). Then, the video signal based on the generated pictures is output to the display 12, and the screen image based on the video signal is displayed on the display unit 12, thereby enabling the user to view a DVD video.

The CPU 11 properly reads, into the main memory 14, the operating system (OS) and pieces of application software such as the moving picture reproducing program and the display control program, which are stored in the storage unit 17, and then executes the OS and these applications, thereby carrying out an arithmetic process of the information inputted from the operation input unit 13, the tuner 18 and the network device and the information read from the storage unit 17. Particularly in this embodiment, the CPU 11 functions as the moving picture reproducing unit 21 by executing the moving picture reproducing program, and functions as the window status detecting unit 14 and the display control unit 16 by executing the display control program.

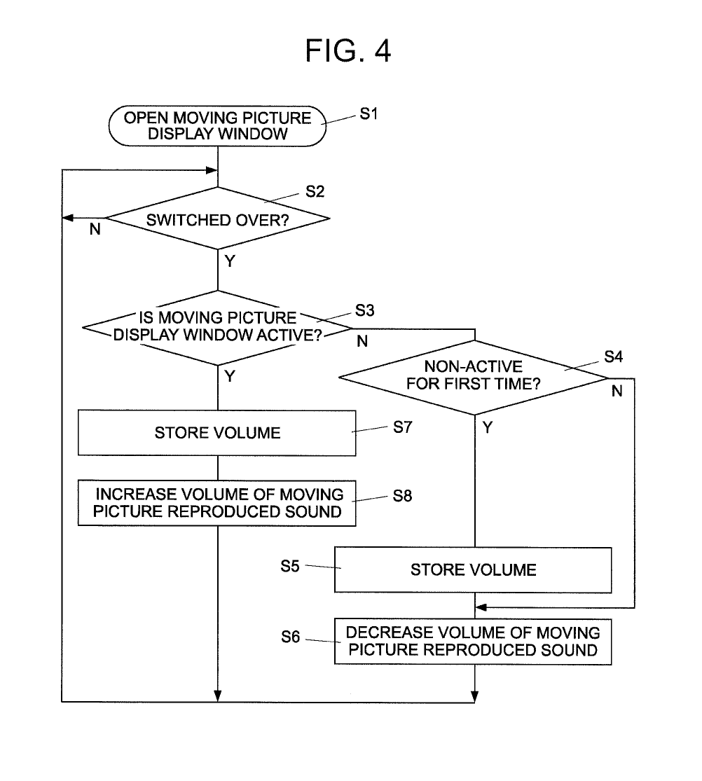

FIG. 4 is an explanatory diagram of a control method executed by the computer 10 in the present embodiment according to the program when switching over the active window.

When the user selects the reproduction of the moving picture with the keyboard and the mouse or selects the TV button 31, the DVD button 32 or the network TV button 33 of the remote controller 13B, the moving picture reproducing program (the TV reproducing application 28A, the DVD moving picture reproducing application 28B or the network distribution moving picture reproducing application 28C) is started up, and the video signal generated by the moving picture reproducing unit 21 in accordance with the moving picture reproducing program is displayed in a moving picture display window through the display control unit 16 (step 1, which will hereinafter be abbreviated as S1). In the present embodiment, the window status detecting unit 14 determines, as the moving picture display window, the window in which the video signal from the moving picture reproducing unit 21 is displayed. Further, without being limited to this scheme, the window status detecting unit 14 may, when the reproduction of predetermined moving picture data is selected, e.g., when the reproduction of a file attached with a predetermined extension such as “.mpg”, “.avi”, etc. or the streaming data is selected, determine the window in which the data is displayed as the moving picture display window. Moreover, without being limited to the moving picture, a case of determining whether the window is a sound output window or not may involve determining whether or not the window is a window related to a predetermined application program such as Media Player or determining, if the reproduction of the file attached with the extension such as “.wav”, “.MP3”, etc. is selected, the window in which this data is reproduced as the sound output window.

Then, the window status detecting unit 14 detects at an interval of a predetermined period (on a per-100 ms basis in this embodiment) whether the status of the moving picture display window is switched over or not, i.e., detects by polling whether the moving picture display window is switched over to the active status or the non-active status (S2).

The window status detecting unit 14 stands by if there is no switchover of the moving picture display window but detects whether the moving picture display window is active or not if there is the switchover of the moving picture display window (S3).

Herein, when determining that the moving picture display window is switched over to the non-active status, the window status detecting unit 14 further determines whether this switchover is done for the first time or not (S4). For example, it is determined whether or not this switchover is done for the first time after installing the moving picture display program or done for the first time during a period since the moving picture display program has been started up till the program is terminated.

If the moving picture display window is switched over to the non-active status for the first time, the volume control unit 23 stores, as the standard volume, the volume of the present moving picture reproduced sound in the storage unit 17 (S5), and changes the volume of the moving picture display window down to a predetermined small volume (S6). Herein, as the predetermined small volume, a default value may be previously set, and the user may also input and store (set) a desired volume in the storage unit 17.

Furthermore, if it is not the first time that the moving picture display window is switched over to the non-active status in step 4, i.e., if the standard volume has already been set (recorded), the volume control unit 23 omits recording the standard volume and changes the moving picture reproduced sound down to the small volume (S6).

Whereas if it is determined in step 3 that the moving picture display window is switched to the active status, the volume control unit 23 stores, as the small volume, the volume of the present moving picture reproduced sound in the storage unit 17 (S7), and changes the volume setting for the moving picture display window up to the standard volume (S8).

Note that the processing flow described above involves updating the volume of the moving picture reproduced sound and the setting value on the occasion of switching over the active window, however, when the active window is not switched over, i.e., when the moving picture display window remains active or non-active, it is also feasible to update the volume of the moving picture reproduced sound and the setting value.

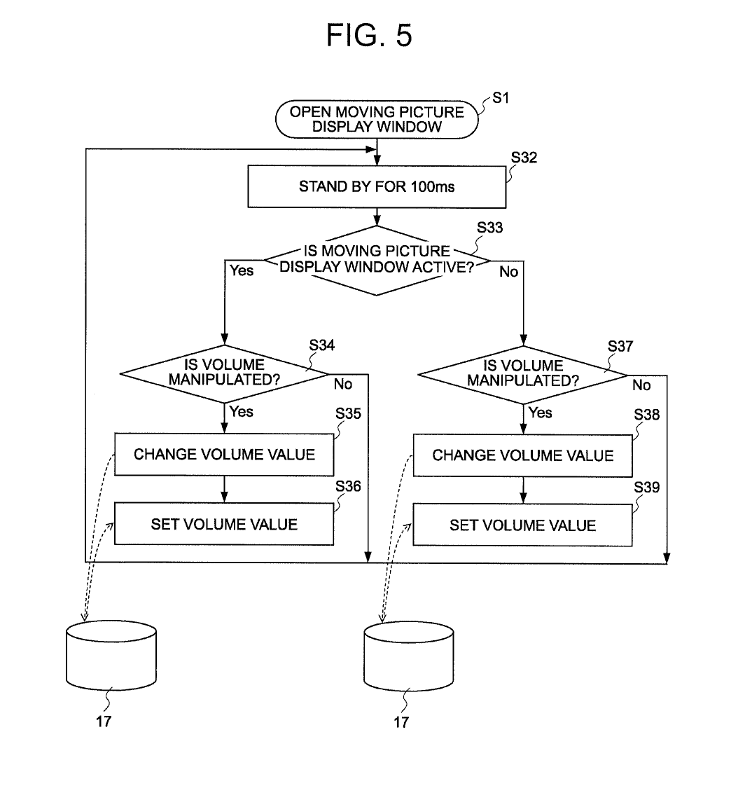

FIG. 5 is an explanatory flowchart of a process of updating the volume of the moving picture reproduced sound and the setting value without switching over the active window.

After starting up the moving picture display program (S1), the volume control unit 23 determines at the interval of the predetermined period (100 ms in this embodiment) whether the moving picture display window is active or not (S32, S33).

Then, the volume control unit 23 detects whether a volume changing operation is conducted or not (S34), then loops back to step 32 if not conducted but changes the volume of the moving picture reproduced sound to a volume corresponding to the operation whereas if conducted (S35), and stores this changed volume as the standard volume in the storage unit 17 (S36).

While on the other hand, when determining in step 33 that the moving picture display window is in the non-active status, the volume control unit 23 detects whether the volume changing operation is performed or not (S37), then loops back to step 32 if not performed but changes the volume of the moving picture reproduced sound to a volume corresponding to the operation whereas if performed (S38), and stores this changed volume as the small volume in the storage unit 17 (S39).

Note that in the case of thus periodically reflecting the change in volume on the setting value, if the moving picture display window is operated by the selection input unit 13A such as the mouse in order to change the volume of the moving picture reproduced sound in the non-active status, it follows that the moving picture display window is to be switched over to the active status, and it is therefore desirable that the volume is changed by the specific input unit 13B such as the remote controller. If operated by the specific input unit 13B, because of the input target being specified and because of not selecting the window, it does not happen that the active window is switched over when performing the operation. For example, the volume is adjusted by the volume-up button 36 and the volume-down button 37 of the controller B1. Further, if the volume of the moving picture reproduced sound is changed by the operation such as changing a master volume of the OS in a way that opens other than the moving picture display window, the volume can be changed even by the selection input unit 13A such as the mouse when the moving picture display window is in the non-active status.

Thus, according to the present embodiment, when the user performs the operation such as selecting the window with the selection input unit 13A, the electronic device 10 automatically changes the volume of the output sound by detecting the switchover of the active window. Accordingly, in the case of viewing the moving picture while conducting the main operation such as creating a document and checking a mail, it is feasible to reduce user's time-consuming operations of decreasing the volume and returning the decreased volume up to the standard volume.

### Modified Example

In the embodiment discussed above, the standard volume and the small volume may be set to arbitrary volumes on condition that the small volume is smaller than the standard volume.

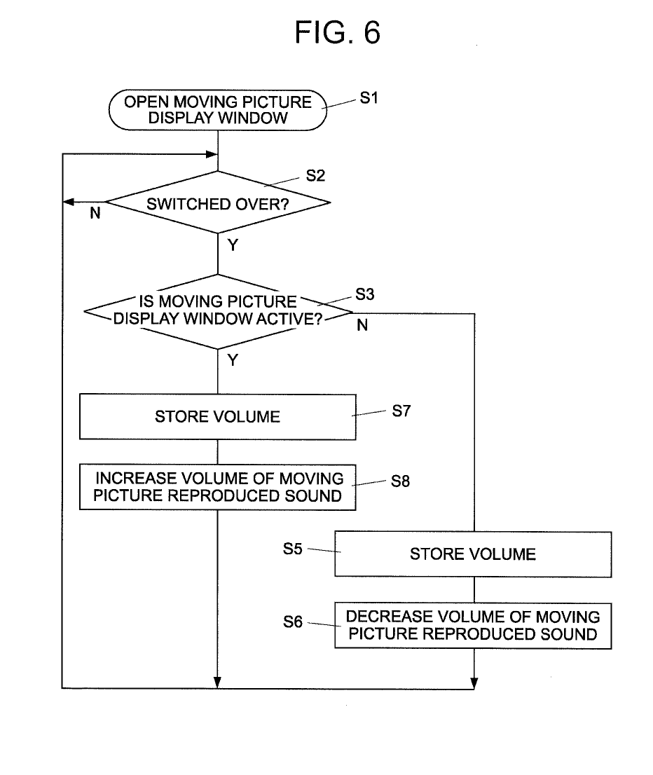

Further, in the example of FIG. 4, the standard volume is recorded if the moving picture display window is switched over to the non-active status for the first time, however, without being limited to this scheme, another available scheme is that the standard volume is, as illustrated in FIG. 6, recorded each time the moving picture display window is switched over to the non-active status in a way that omits step 4.

Still another available scheme is not to record the volume when switched over in a way that omits steps 5 and 7 in FIG. 6 but to change the volume to a preset volume.

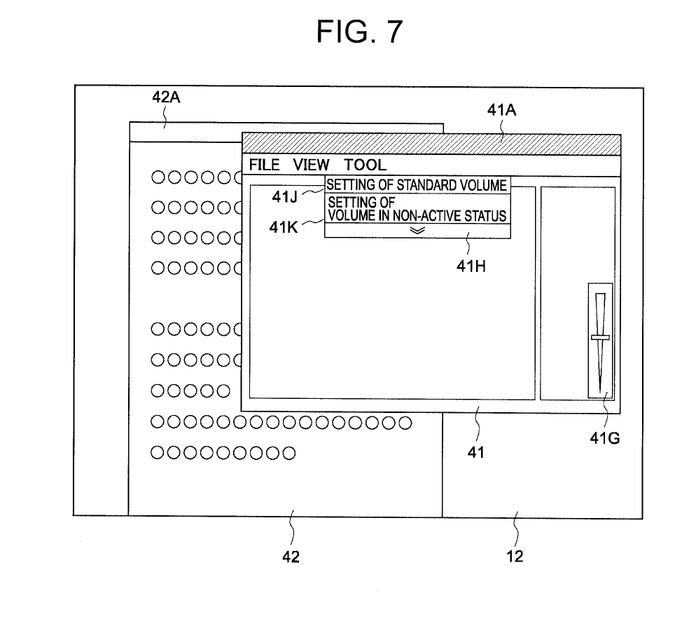

In the case of presetting the setting value of the volume, without being limited to the automatic update illustrated in FIG. 5, the user may arbitrarily set the volume setting value by operating the user interface. For example, as illustrated in FIG. 7, the user adjusts the volume to a desired volume by manipulating a volume 41G of the moving picture display window with the operation input unit 13A, in which state the user opens a setting menu 41H and selects a setting 41J of the standard volume (the first value). Corresponding to this volume setting, the electronic device 10 stores, as the first value, the volume given when selecting the setting 41J of the standard volume in the storage unit 17.

Moreover, with respect to the small volume (the second value), similarly, the user adjusts the volume to a desired volume by manipulating the volume 41G of the moving picture display window with the operation input unit 13A, in which state the user opens the setting menu 41H and selects a setting 41K of the small volume (the second value). Corresponding to this volume setting, the electronic device 10 stores, as the second value, the volume given when selecting the setting 41K of the small volume in the storage unit 17.

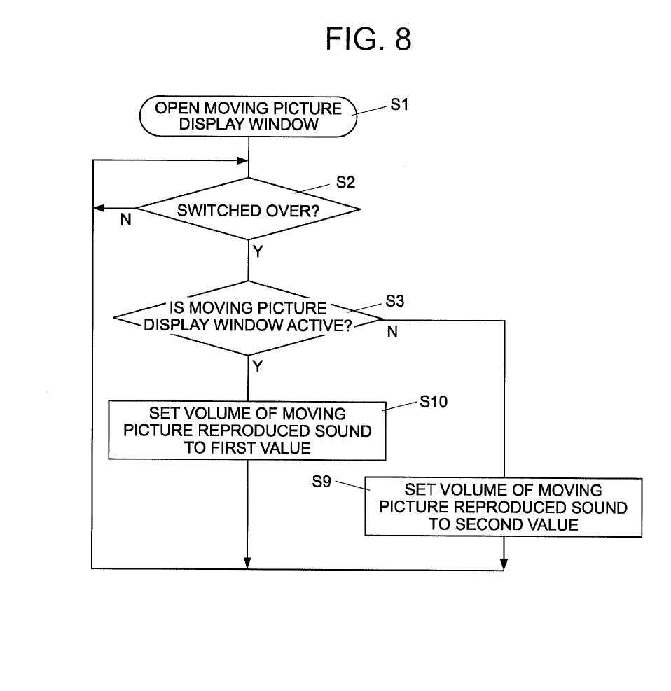

FIG. 8 is an explanatory flowchart of the control method of changing the volume for the moving picture display window to the preset first value or second value, corresponding to the switchover of the active window.

As described above, it is determined whether the moving picture display window is switched over to the active status or not (S1-S3), and the output sound is changed to the first value from the second value when switched over to the active status (S10) and changed to the second value from the first value when switched over to the non-active status (S9).

Note that the second value may be, without being limited to the absolute value explained in FIG. 5 or 7, set to a relative value so as to become the volume decreased at a predetermined rate from the volume (the first value) when the moving picture display window is active.

For instance, if ½ or ⅓ is set as the second value, when the moving picture display window is switched over to the non-active status, the output sound of the first value is changed to the ½ or ⅓ value.

Similarly, in the processing method of FIG. 4, the second value is set at a rate with respect to the first value, and, as in step 5, the current volume (the volume when active) is stored as the standard volume when the moving picture display window is switched over to the non-active status, in which case the moving picture display window is set to the volume lowered (decreased) at the predetermined rate from the volume given when active in step 6.

### Second Embodiment

A second embodiment according to the present invention will be next discussed. The present embodiment is different from the embodiment discussed above in terms of a point of changing the window size simultaneously with changing the volume.

Note that the hardware configuration is the same as in the first embodiment described above, and hence the same components are marked with the same numerals and symbols, while their repetitive explanations are omitted.

In the case of performing another operation while displaying the moving picture, if the moving picture display window is hidden when selecting another window, the user is disabled from viewing the moving picture display window and therefore conducts the operation of decreasing the window size to such an extent that the moving picture display window is not hidden while being shifted to a screen edge.

Such being the case, in the second embodiment, the window size is automatically changed simultaneously with changing the volume. Hence, the display control unit 16, if the switchover of the active window is the switchover from the moving picture display window to another window, changes the size of the moving picture display window to a small size (which is also referred to as a second window size) from a size (which is also termed a standard size or a first window size) when active. Further, if switched over to the moving picture display window from another window, the size of the moving picture display window is changed to the original size (the first window size).

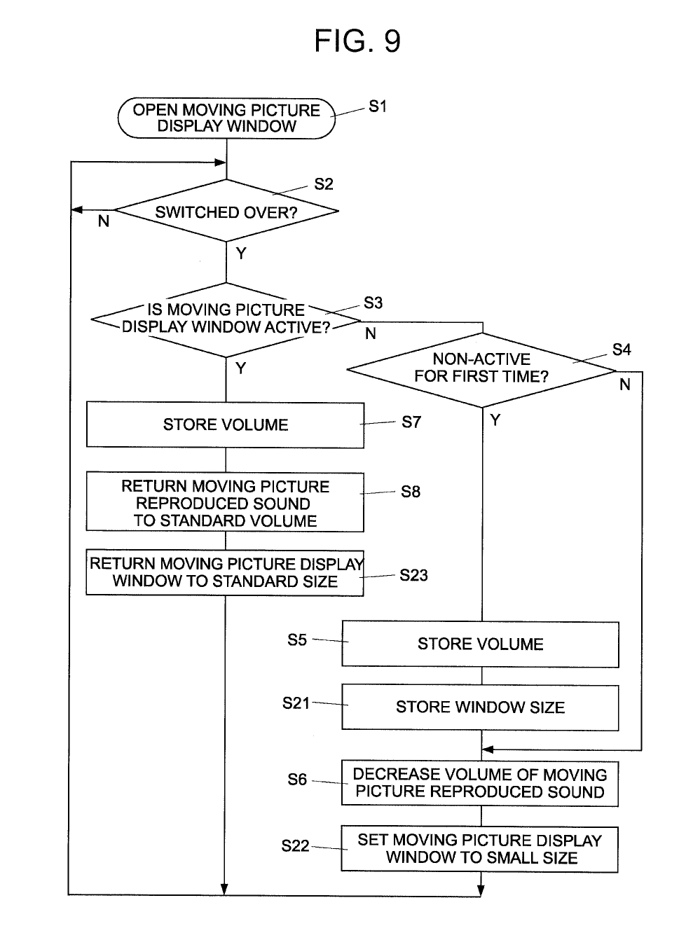

FIG. 9 is an explanatory flowchart illustrating a control method that is executed based on a program by the computer 10 in the second embodiment when switching over the active window.

When the user selects the reproduction of the moving picture with the keyboard or the mouse or selects the TV button 31, the DVD button 32 or the network TV button 33 of the remote controller 13B, the moving picture reproducing program (the TV reproducing application 28A, the DVD moving picture reproducing application 28B or the network distribution moving picture reproducing application 28C) is started up, and the video signal generated by the moving picture reproducing unit 21 in accordance with the moving picture reproducing program is displayed in the moving picture display window through the display control unit 16 (S1).

Then, the window status detecting unit 14 detects at the interval of the predetermined period (on the per-100 ms basis in this embodiment) whether the status of the moving picture display window is switched over or not, i.e., detects by polling whether the moving picture display window is switched over to the active status or the non-active status (S2).

The window status detecting unit 14 stands by if there is no switchover of the moving picture display window but determines whether the moving picture display window is active or not if there is the switchover of the moving picture display window (S3).

Herein, when determining that the moving picture display window is switched over to the non-active status, the window status detecting unit 14 further determines whether this switchover is done for the first time or not (S4).

If the moving picture display window is switched over to the non-active status for the first time, the volume control unit 23 stores, as the first value, the volume of the present moving picture reproduced sound in the storage unit 17 (S5). Further, the display control unit 16 stores, as the first window size, the size of the current moving picture display window in the storage unit 17 (S21).

After step 21 or if not done for the first time in step 4, the volume control unit 23 changes the volume of the moving picture reproduced sound to the predetermined small volume (the second value) (S6). Herein, the volume given when the moving picture display window is non-active is stored as the predetermined second value beforehand in the storage unit 17.

Further, the display control unit 16 changes the size of the moving picture display window to a predetermined second window size (S22). Herein, as the predetermined second window size, a default value may be set previously, and the user may input a desired size through the operation input unit 13 and stores (sets) this size in the storage unit 17.

Note that the display control unit 16, when the size of the moving picture display window is changed to the second window size, does not change only the window size but displays a reduced moving picture adjusted to the window size without changing an aspect ratio.

While on the other hand, it is determined in step 3 that the moving picture display window is switched over to the active status, and the volume control unit 23 stores the current moving picture reproduced sound as the second value in the storage unit 17 (S7) and changes the volume of the moving picture reproduced sound to the standard volume (the first value) (S8).

Moreover, the display control unit 16 refers to the storage unit 17 and changes the size of the moving picture display window to the first window size (S23).

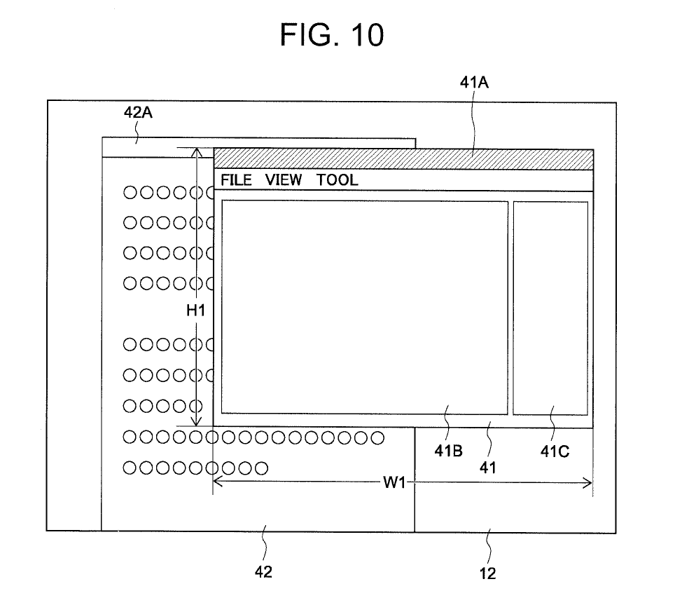

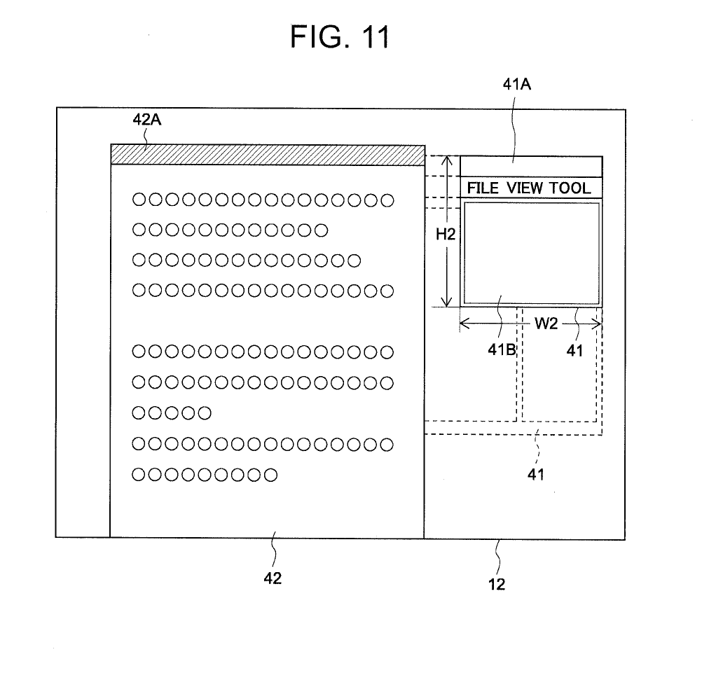

FIGS. 10 and 11 are explanatory diagrams of the statuses of the window that is switched over by the control method described above.

In FIGS. 10 and 11, the numeral 41 represents the moving picture display window, 42 denotes another window, and a window with highlighted (hatched in the figures) title bar 41A or 42A represents an active window.

When the user wants to view the moving picture, the moving picture display window 41 is selected, then made active and displayed on a foremost screen as depicted in FIG. 10. The first window size is the window size W1×H1 in this situation.

Then, when the user wants to perform another operation while viewing the moving picture, another window 42 is selected to thereby switch over the active window and is thus displayed on the foremost screen as illustrated in FIG. 11.

At this time, the window status detecting unit 14 detects that the moving picture display window 41 is switched over to the non-active status, and the display control unit 16 changes over the size of the moving picture display window 41 to a second window size (W2×H2).

Moreover, as illustrated in FIG. 10, the moving picture display window 41 includes a moving picture display sub-window 41B for displaying the moving picture and an information display sub-window 41C for displaying items of information such as a title and a caption of the moving picture, in which case the information display sub-window 41C may be omitted (non-displayed) on the occasion of making the change to the second window size.

Thus, according to the second embodiment, when the user conducts the operation such as selecting the window with the selection input unit 13, the electronic device 10 detects the switchover of the active window and automatically changes the size of the moving picture display window and the volume of the moving picture reproduced sound. Accordingly, in the case of viewing the moving picture while performing the main operations of creating the document, checking the mails and so on, it is feasible to lighten the user's time-consuming operations such as reducing the size of the moving picture display window so as not to be hidden, returning the reduced size of the moving picture display window to the standard size and lowering the volume of the moving picture reproduced sound.

In the embodiment discussed above, the first window size and the second window size, if the second window size is smaller than the first window size, may be set to arbitrary sizes.

### Modified Example

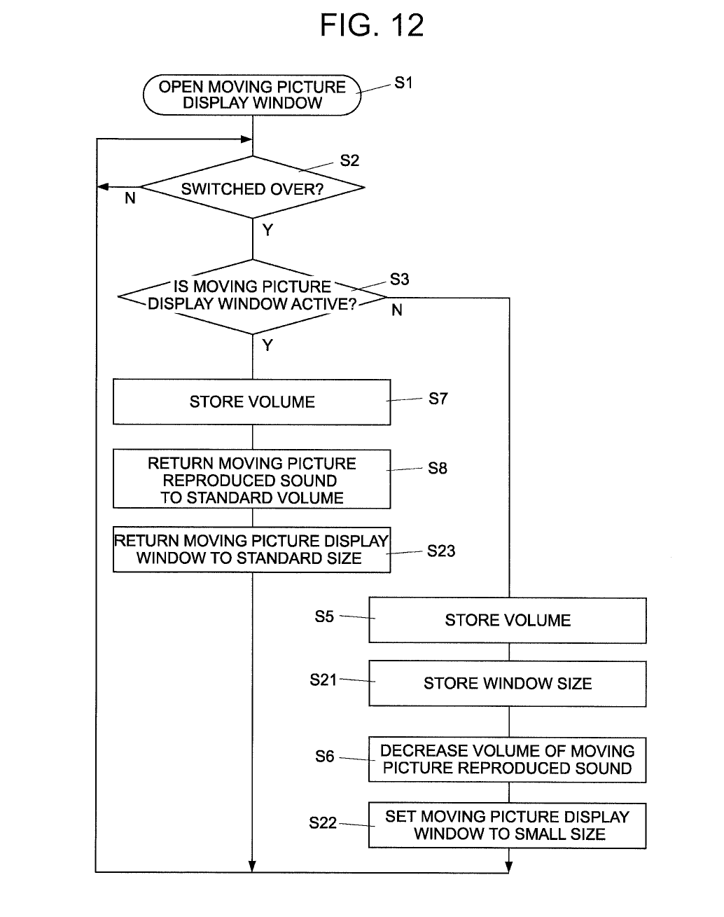

Furthermore, in the example of FIG. 9, if the moving picture display window is switched over to the non-active status for the first time, the first window size is recorded, however, without being limited to this process, as illustrated in FIG. 12, the first window size may be recorded each time the moving picture display window is switched over to the non-active status in a way that omits step 4.

Still another available scheme is not to record the first window size when switched over in a way that omits step 21 in FIG. 9 but to change the size to a preset size.

In the case of presetting the first window size, for example, the user opens a setting menu a status of adjusting the moving picture display window to a desired size with the operation input unit 13A and selects a setting (unillustrated) of the first window size. Corresponding to this operation, the electronic device 10 stores, as the first window size, the moving picture display window size given when selecting the setting of the first window size in the storage unit 17.

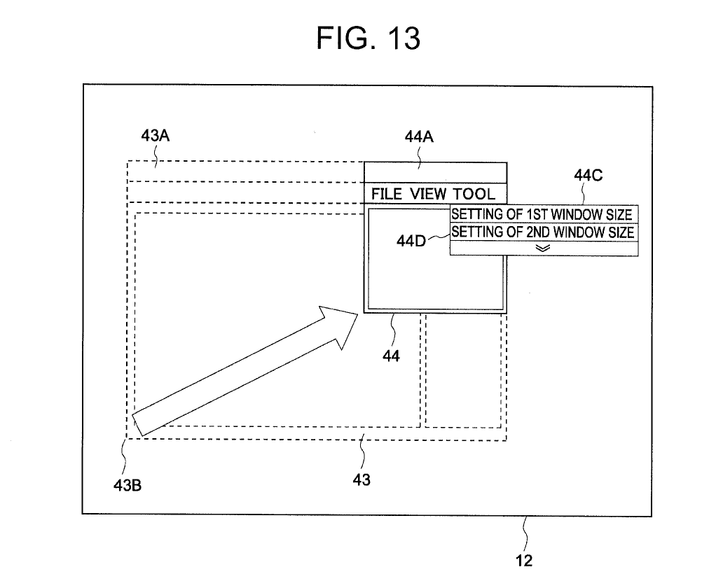

Moreover, the same setting can be also applied to the second window size. For example, the user drags a left lower corner 43B of the moving picture display window 43 depicted in FIG. 13 up to a right upper corner with the mouse, then reduces the window 43 down to a moving picture display window 44 having a desired size, and selects a setting 44D of the second window size by opening a selection menu 44C. Corresponding to this operation, the electronic device 10 stores, as the second window size, the moving picture display window size given when selecting the setting 44D of the second window size in the storage unit 17.

Note that a relative value may be, without being restricted to the absolute value explained in FIG. 13, set in the second window size so as to become a size lowered (reduced) at a predetermined rate from the size (the first window size) when the moving picture display window is active.

For example, if the second window size is set to ½ or ⅓, when the moving picture display window is switched over to the non-active status, the moving picture display window having the first window size is changed to the ½ or ⅓ size.

Similarly, in the processing method of FIG. 9, the second window size is set at a rate with respect to the first window size, and, as in step 21, the current window size (the size when active) is stored as the first window size when the moving picture display window is switched over to the non-active status, in which case the moving picture display window is set to the size lowered (reduced) at the predetermined rate from the size when active in step 22.

Moreover, as illustrated in FIG. 10, the moving picture display window 41 having the first value includes the moving picture display sub-window 41B for displaying the moving picture and the information display sub-window 41C for displaying items of information such as the title and the caption of the moving picture, in which case the information display sub-window 41C may be omitted (non-displayed) on the occasion of making the change to the second window size as illustrated in FIG. 11.

Moreover, the case of changing the moving picture display window down to the small size may involve taking a scheme of reducing the window on the basis of a predetermined position such as the corner and the center of the window. For instance, in FIG. 11, the window is reduced in a way that sets the right upper corner as the base position. This base position is preset and stored in the storage unit 17. For example, as illustrated in FIG. 13, in the case of setting the window down to the small size by dragging the left lower corner to the right upper corner as the base position (a fixed point), the base position (the right upper corner in FIG. 13) is stored together with the window size.

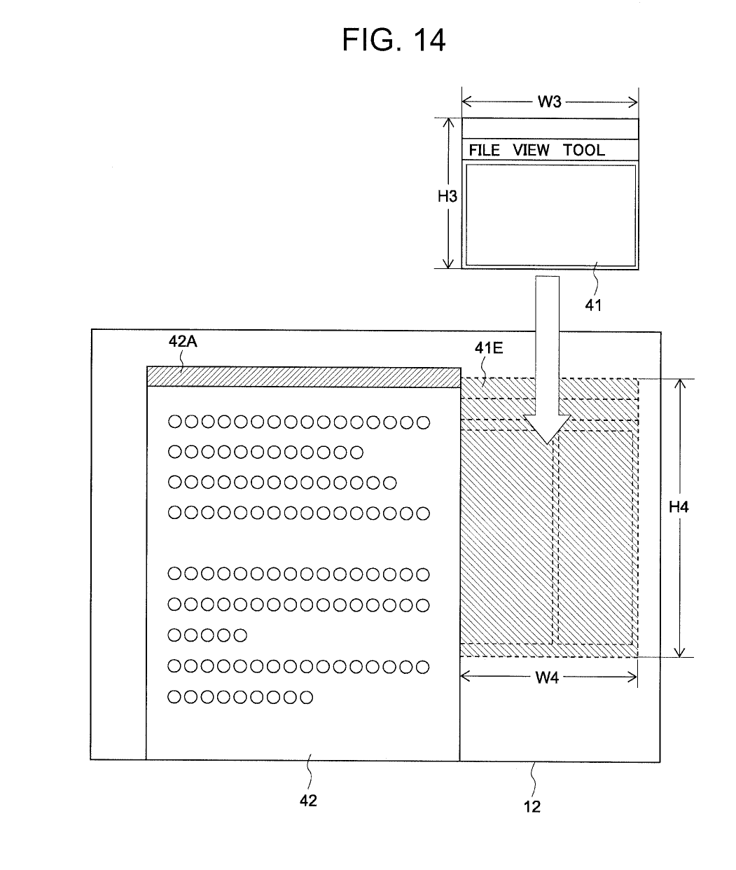

Moreover, in the case of changing the size of the moving picture display window to the small size, an available scheme is, without being limited to the predetermined size, that the size is changed so as not to be overlapped with the active window. For instance, as illustrated in FIG. 14, the moving picture display window 41 is switched over to the non-active status while another window 42 is switched over to the active status with the result that the moving picture display window 41 is partly hidden, in which case the size may be changed so as to be accommodated within an unhidden area (an hatching area) 41E. Namely, the size is determined so that a width W3 and a height H3 of the moving picture display window 41 reduced without changing the aspect ratio of the moving picture display sub-window 41B are equal to or smaller than a width W4 and a height H4 of the unhidden area 41E.

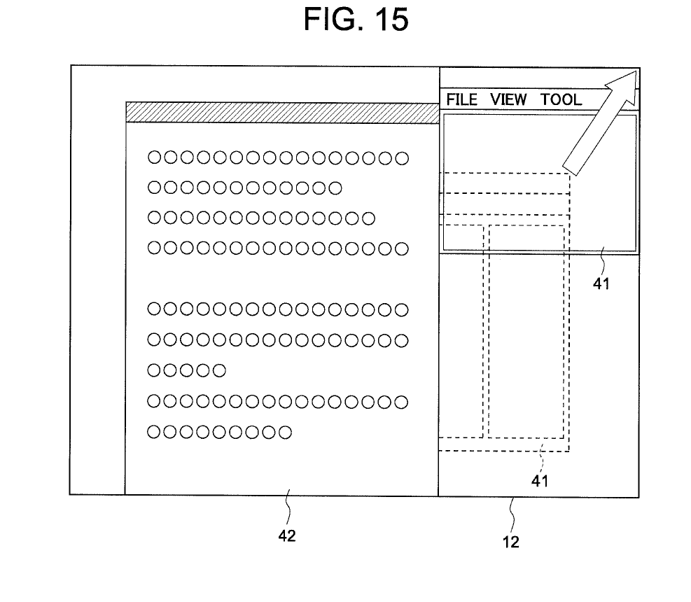

Still further, in the case of changing the size of the moving picture display window down to the small size, the size may be changed to the second window size or the size that is not overlapped with the active window by shifting the moving picture display window. For example, as depicted in FIG. 15, the moving picture display window is shifted to a predetermined position (a right upper corner in FIG. 15) or in a predetermined direction. The predetermined position and the predetermined direction are stored (set) in the storage unit 17 beforehand. Note that a pre-shifting position of the moving picture display window is also recorded when switched over to the non-active status, and, when switched over to the active status, the moving picture display window is returned to this recorded original position.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

What is claimed is:

1. An electronic device on which a multi-window system operates, comprising:
a detecting unit to detect a switchover of an active window; and
a volume control unit to change, when the switchover of the active window is a switchover to another window from a sound output window defined as a user interface for a process of outputting a sound, a volume setting value relating to the output sound by the process of the sound output window.

2. The electronic device according to claim 1, wherein said volume control unit changes the volume setting value relating to the output sound by the process of the sound output window to a small volume from the volume setting value in an active window status.

3. The electronic device according to claim 2, wherein said volume control unit changes the volume setting value relating to the output sound by the process of the sound output window to a volume setting value into which the volume setting value in the active window status is decreased at a predetermined rate.

4. The electronic device according to claim 1, wherein said volume control unit stores, when the switchover of the active window is a switchover from the sound output window to another window, a value set as the volume setting value relating to the output sound by the process of the sound output window in storage unit, and sets, when the switchover of the active window is a switchover from another window to the sound output window, the value stored in said storage unit to the volume setting value relating to the output sound by the process of the sound output window.

5. The electronic device according to claim 1, further comprising a storage unit stored with a first value defined as a volume setting value for an active window status and a second value defined as a volume setting value for a non-active window status,
wherein said volume control unit changes, upon the switchover of the active window, the volume setting value relating to the output sound by the process of the sound output window to the second value from the first value.

6. The electronic device according to claim 5, further comprising a first user interface enabling a user to change the first value.

7. The electronic device according to claim 5, further comprising a second user interface enabling a user to change the second value.

8. The electronic device according to claim 1, further comprising a display control unit to change, when the switchover of the active window is the switchover from the sound output window to another window, the sound output window to a window of a small size from the present size.

9. The electronic device according to claim 1, wherein the sound output window is a window for outputting a received broadcast.

10. The electronic device according to claim 1, wherein the process of outputting the sound is a process which accompanies displaying a moving picture, and
the sound output window is a window in which the moving picture is displayed.

11. A control method executed by an electronic device on which a multi-window system operates, said method comprising:
detecting a switchover of an active window; and
changing, when the switchover of the active window is a switchover from a sound output window to another window, a volume setting value relating to the output sound by a process of the sound output window.

12. The control method according to claim 11, wherein said changing changes the volume setting value relating to the output sound by the process of the sound output window to a value for a low volume from the volume setting value in an active window status.

13. The control method according to claim 12, wherein said changing changes the volume setting value relating to the output sound by the process of the sound output window to a volume setting value into which the volume setting value in the active window status is decreased at a predetermined rate.

14. The control method according to claim 11, wherein said changing includes:
storing, when the switchover of the active window is a switchover from the sound output window to another window, a value set as the volume setting value relating to the output sound by the process of the sound output window in a storage unit; and
setting, when the switchover of the active window is a switchover from another window to the sound output window, the value stored in said storage unit to the volume setting value relating to the output sound by the process of the sound output window.

15. The control method according to claim 11, further comprising storing a first value defined as a volume setting value for an active window status and a second value defined as a volume setting value for a non-active window status,
wherein said changing changes, upon the switchover of the active window, the volume setting value relating to the output sound by the process of the sound output window to the second value from the first value.

16. The control method according to claim 15, further comprising changing the first value on the basis of a user's changing operation using a first user interface.

17. The control method according to claim 15, further comprising changing the second value on the basis of the user's changing operation using a second user interface.

18. The control method according to claim 11, further comprising changing, when the switchover of the active window is the switchover from the sound output window to another window, the sound output window to a window of a small size from the present size.

19. A non-transitory storage medium storing a program that causes, when read and executed by the electronic device, the electronic device to perform:
detecting a switchover of an active window; and
changing, when the switchover of the active window is a switchover from a sound output window to another window, a volume setting value relating to an output sound by a process of the sound output window.

20. The non-transitory storage medium according to claim 19, wherein said program causes the electronic device to further perform changing, when the switchover of the active window is the switchover from the sound output window to another window, the sound output window to a window of a small size from the present size.
